(19) United States
(12) Patent Application Publication
(10) Pub. No.: US 2014/0298361 A1
(43) Pub. Date: Oct. 2, 2014

(54) Remote User Interface

(71) Applicant: Cisco Technology Inc., San Jose, CA (US)

(72) Inventors: Vincent Cussonneau, Fontenay-sous-Bios (FR); David Sahuc, Paris (FR); Bruno Boru, Etiolles (FR); Bruno Giordano, Issy-les-Moulineaux (FR)

(21) Appl. No.: 14/350,657

(22) PCT Filed: Oct. 12, 2012
(86) PCT No.: PCT/IB2012/055553

§ 371 Date: Apr. 9, 2014

Related U.S. Application Data
(60) Provisional application No. 61/627,508, filed on Oct. 12, 2011.

(51) Int. Cl. G06F 9/54

(52) U.S. Cl. CPC G06F 9/541
USPC 719/328

(57) ABSTRACT

A method for delivering a remote user interface is described. The method includes: providing at a first device a plurality of API implementations enabling a plurality of features such that, each of the plurality of features is enabled by at least one of the plurality of API implementations, the plurality of features enabling a plurality of services such that, each of the plurality of features at least partially enables at least one of the plurality of services; receiving a request for transmitting a user interface to a second device, the user interface enabling a user of the second device to access and make use of one or more services from the plurality of services, wherein the request further includes a set of parameters characterizing the second device; identifying the second device using the set of parameters; identifying API implementations from the plurality of API implementations to provide to the identified second device, wherein one or more features from the plurality of features is enabled by the identified API implementations, and wherein the one or more features enable the one or more services to be accessed and used at the identified second device; and transmitting the identified API implementations along with the user interface from the first device to the identified second device. Related systems, apparatus and methods are also described.

### FIELD OF THE INVENTION

The present invention relates to apparatus and methods related to remote user interfaces.

### BACKGROUND OF THE INVENTION

In recent years, and particularly with the advent of powerful yet portable Consumer Electronic (CE) devices, pay-television (pay-TV) operators are facing a growing challenge to meet their subscribers' demand for a premium content viewing experience on a multitude of client devices, no longer limited to Set-Top Boxes (STBs). These client devices may be, for example, computers, mobile phones, tablet computers or any handheld devices.

Additionally, growing competition means that pay-TV operators are providing ever more advanced services typically requiring end-to-end service orchestration and a greater involvement of the headend—whether it is for transcoding, business logic, or third party service enablement using the pay-TV operator's infrastructure.

It is desirable for a subscriber to be exposed to a coherent and consistent service, which maintains a consistent user experience between the different client devices that may be used to access the services. Since the UI is the visual mechanism by which a subscriber discovers and accesses a service or associated content, the concept of the remote user interface (RUI) was developed.

A RUI is one solution to the problem of offering a unified and consistent user experience across multiple client devices. The RUI paradigm includes the following concepts:
the UI may be delivered either partially or fully constructed from a server/Gateway (GW), to a plurality of client devices;
the server/GW may be located at (or just outside) the subscriber's premises, at a remote headend and/or distributed on both sides;
the client devices accessing the UI may have a plurality of display technologies; and
the UI may have to work across a wide range of client devices.

Current known Remote User Interface (RUI) technologies are described in a paper called “Remote UI protocols for home environment” presented at a Seminar T-110.5190 on Internetworking held at the Telecommunications Software and Multimedia Laboratory of Helsinki University of Technology in Spring 2007 by Juha Leppilahti. Binary User Interface (UI) protocols aim at transferring the native UI with the native look and feel whereas markup protocols transfer the description of the UI and hence allow unified look and feel that best suits the displaying device. Known protocols that may be used in RUIs are Widex and Universal Plug and Play (UPnP). UPnP is an interoperability enabler that supports multiple remoting protocols. Widex has eXtensible Markup Language (XML) Document Object Model (DOM) based UI support and hence a generic and flexible architecture for UI rendering.

The RVU Alliance also developed and made available technical specifications for the distribution of digital audio/video home networked entertainment content augmented with pixel accurate remote user interface graphics based on the RVU protocol. The RVU protocol is an application layer protocol that combines the pre-existing Digital Living Network Alliance (DLNA) standards and a new Remote User Interface (RUI) protocol, which works in a similar way to the Remote Desktop Protocol (RDP). The RVU RUI protocol is intended to allow an RVU-enabled client, such as a TV, to receive a pixel-accurate display of the user interface available on an RVU server.

US Published Patent Application 2011/0283232 of Jordan et al. also describes a computer-implemented system and method providing a user interface for content browsing and selection in a content system. Embodiments include: gathering available content information related to a plurality of content items from a plurality of content sources via a data network, the plurality of content sources including a public content source and a personal content source; processing the content information, using a processor, to provide digital representations of the plurality of content items, the digital representations including a digital representation of a public content item from the public content source and a digital representation of a personal content item from the personal content source; and displaying available content information related to the selected content item in response to receiving a selection of the content item, the available content information including at least one user-selectable command option for obtaining an additional level of detailed information related to the selected content item.

### SUMMARY OF THE INVENTION

An issue with unmanaged (inter-)communications networks is the complexity of ensuring a consistent Quality of Service (QoS). This is due to the bandwidth variability at each stage of the delivery chain, and also to the coexistence of a wide range of services competing for priority across those same communications networks. In a case of pure video delivery, development of technologies such as Adaptive BitRate (ABR) encoding may be helpful ensuring a consistent QoS remains important for the RUI to provide the best user experience while optimizing the bandwidth availability.

Furthermore, the continuing development of cheaper, yet higher performance hardware for both vertical and horizontal platforms means that a richer and more dynamic user experience may be executed on a large selection of client devices with different presentation engines. In trying to reach these client devices, deployment of native applications quickly developed. These applications also highlighted the value of better use of richer aggregated metadata bringing enhanced user experience. The companies operating in the CE devices space, along with TV operators, are facing issues with native applications in terms of cost of multiple development strains as well as ongoing support/upgrades. Pay-TV operators are also facing the same issues (with TV applications such as Electronic Program Guides (EPGs) for instance) since they have been targeting seamless service integration and these applications are usually not designed to work on different screen resolutions or with different remote controls.

There is thus provided in accordance with an embodiment of the present invention a method including: providing at a first device a plurality of API implementations enabling a plurality of features such that, each of the plurality of features is enabled by at least one of the plurality of API implementations, the plurality of features enabling a plurality of services such that, each of the plurality of features at least partially enables at least one of the plurality of services; receiving a request for transmitting a user interface to a second device, the user interface enabling a user of the second device to access and make use of one or more services from the plurality of services, wherein the request further includes a set of parameters characterizing the second device; identifying the second device using the set of parameters; identifying API implementations from the plurality of API implementations to provide to the identified second device, wherein one or more features from the plurality of features is enabled by the identified API implementations, and wherein the one or more features enable the one or more services to be accessed and used at the identified second device; and transmitting the identified API implementations along with the user interface from the first device to the identified second device.

Further, in accordance with an embodiment of the present invention, the method further includes: storing layouts, contents and metadata related to a plurality of services to be made available to a plurality of client devices at the first device; identifying layouts, contents and metadata relevant to the user interface, the layouts, contents and metadata being in a format suitable for display and use at the identified second device; and transmitting the identified layouts, contents and metadata relevant to the user interface to the identified second device.

Still further, in accordance with an embodiment of the present invention, the receiving includes receiving a request for transmitting a subset of a user interface.

Additionally, in accordance with an embodiment of the present invention, the user interface is an electronic program guide, the electronic program guide including a plurality of visual elements for display.

Further, in accordance with an embodiment of the present invention, the receiving includes receiving a request for transmitting a subset of a user interface and the subset corresponds to a particular visual element of the electronic program guide.

Still further, in accordance with an embodiment of the present invention, the visual element is a single page of the electronic program guide being displayed in full screen.

Additionally, in accordance with an embodiment of the present invention, the visual element is a widget of the electronic program guide not being displayed in full screen.

Further, in accordance with an embodiment of the present invention, the receiving includes receiving a request from a user of the second device.

Still further, in accordance with an embodiment of the present invention, the receiving a request from a second device includes receiving a request for transmitting a user interface every time the second device is powered on.

Additionally, in accordance with an embodiment of the present invention, the method further includes: receiving a further request for transmitting an updated user interface to the identified second device; and transmitting the updated user interface to the identified second device.

Further, in accordance with an embodiment of the present invention, the receiving a further request includes receiving the further request from the identified second device upon reception by the identified second device of a notification transmitted by the first device, the notification signaling an update of the user interface.

Still further, in accordance with an embodiment of the present invention, the notification is transmitted by a television operator headend.

Additionally, in accordance with an embodiment of the present invention, the notification signals an availability of a new service relevant to the second device.

Further, in accordance with an embodiment of the present invention, the method further includes: identifying API implementations from the plurality of API implementations to provide to the identified second device, wherein one or more features is enabled by the identified API implementations, and wherein the one or more features enable the new service to be accessed and used at the identified second device; and transmitting the identified API implementations along with the updated EPG from the first device to the identified second device.

Still further, in accordance with an embodiment of the present invention, the notification signals an availability of a new layout for the user interface.

Additionally, in accordance with an embodiment of the present invention, the method further includes: identifying the new layout relevant to the updated user interface, the new layout being in a format suitable for display at the identified second device; and transmitting the identified layout relevant to the updated user interface to the identified second device.

Further, in accordance with an embodiment of the present invention, the notification signals an availability of new contents for the user interface.

Still further, in accordance with an embodiment of the present invention, the method further includes: identifying the new contents relevant to the updated user interface, the new contents being in a format suitable for display and use at the identified second device; and transmitting the identified new contents relevant to the updated user interface to the identified second device.

Additionally, in accordance with an embodiment of the present invention, the receiving a further request includes receiving a further request from a second device upon reception by the second device of a notification transmitted by one service from the one or more services available at the identified second device.

Further, in accordance with an embodiment of the present invention, the receiving a further request includes receiving a further request from a second device upon reception by the second device of a user input requesting the electronic program guide to switch from one visual element to another visual element.

Still further, in accordance with an embodiment of the present invention, the set of parameters characterizing the second device includes one or more of: an identifier of the second device; information on data supported by the second device; types of input devices associated to the second device; and types of connections supported by the second device.

Additionally, in accordance with an embodiment of the present invention, the second device is a client device.

Further, in accordance with an embodiment of the present invention, the first device is a server.

Still further, in accordance with an embodiment of the present invention, the first device is another client device.

There is also provided with a further embodiment of the present invention, a server including: a storage module operable to store a plurality of API implementations enabling a plurality of features such that, each of the plurality of features is enabled by at least one of the plurality of API implementations, the plurality of features enabling a plurality of services such that, each of the plurality of features at least partially enables at least one of the plurality of services; a front end module operable to receive a request for transmitting a user interface to a second device, the user interface enabling a user of the second device to access and make use of one or more services from the plurality of services, wherein the request further includes a set of parameters characterizing the second device; a control manager operable to identify the second device using the set of parameters; a processor module to identify API implementations from the plurality of API implementations to provide to the identified second device, wherein the one or more features from the plurality of features is enabled by the identified API implementations, and wherein the one or more features enable the one or more services to be accessed and used at the identified second device; and wherein, the front end module is further operable to transmit the identified API implementations along with the user interface from the first device to the identified second device.

There is also provided with a further embodiment of the present invention, a server including: means for storing a plurality of API implementations enabling a plurality of features such that, each of the plurality of features is enabled by at least one of the plurality of API implementations, the plurality of features enabling a plurality of services such that, each of the plurality of features at least partially enables at least one of the plurality of services. means for receiving a request for transmitting a user interface to a second device, the user interface enabling a user of the second device to access and make use of one or more services from the plurality of services, wherein the request further includes a set of parameters characterizing the second device; means for identifying the second device using the set of parameters; means for identifying API implementations from the plurality of API implementations to provide to the identified second device, wherein the one or more features from the plurality of features is enabled by the identified API implementations, and wherein the one or more features enable the one or more services to be accessed and used at the identified second device; and means for transmitting the identified API implementations along with the user interface from the first device to the identified second device.

### BRIEF DESCRIPTION OF THE DRAWINGS

The present invention will be understood and appreciated more fully from the following detailed description, taken in conjunction with the drawings in which:

FIGS. 1a, 1b and 1c are simplified block diagram illustrations of interaction sequences between a RUI server and a RUI client device according to embodiments of the present invention;

FIG. 2 is a simplified block diagram illustration of an example infrastructure comprising RUI servers and RUI client devices according to an embodiment of the present invention;

FIG. 3 is a simplified block diagram illustration of a RUI server according to an embodiment of the present invention;

FIG. 4 is a simplified block diagram illustration of features which may be made available to RUI client devices according to an embodiment of the present invention;

FIG. 5 is a simplified block diagram illustration of a RUI client device according to an embodiment of the present invention;

FIG. 6 is a simplified block diagram illustration of a RUI EPG and Applications system according to another embodiment of the present invention;

FIG. 7 is a simplified diagram illustration showing a sequence of operations in a RUI EPG and Applications system according to an embodiment of the present invention; and

FIG. 8 is a simplified diagram illustration of a sequence of operations to switch from one widget to another in accordance with an embodiment of the present invention.

### DETAILED DESCRIPTION OF EMBODIMENTS

The present invention, in embodiments thereof, comprises method and apparatus related to an improved RUI that enables, yet simplifies, the delivery of an EPG and/or UI applications, metadata and content in a large ecosystem of client devices across different communication networks. The present invention, in embodiments thereof, comprises:
a RUI enabled Application Programming Interfaces (APIs) system which allows an optimal QoS and user experience to be delivered from a RUI server to a RUI client device; and
a RUI EPG (and/or UI applications) system describing an improved navigation model that may be used with any RUI client device. Communication processes between a RUI server and RUI client devices are also described later in greater detail.

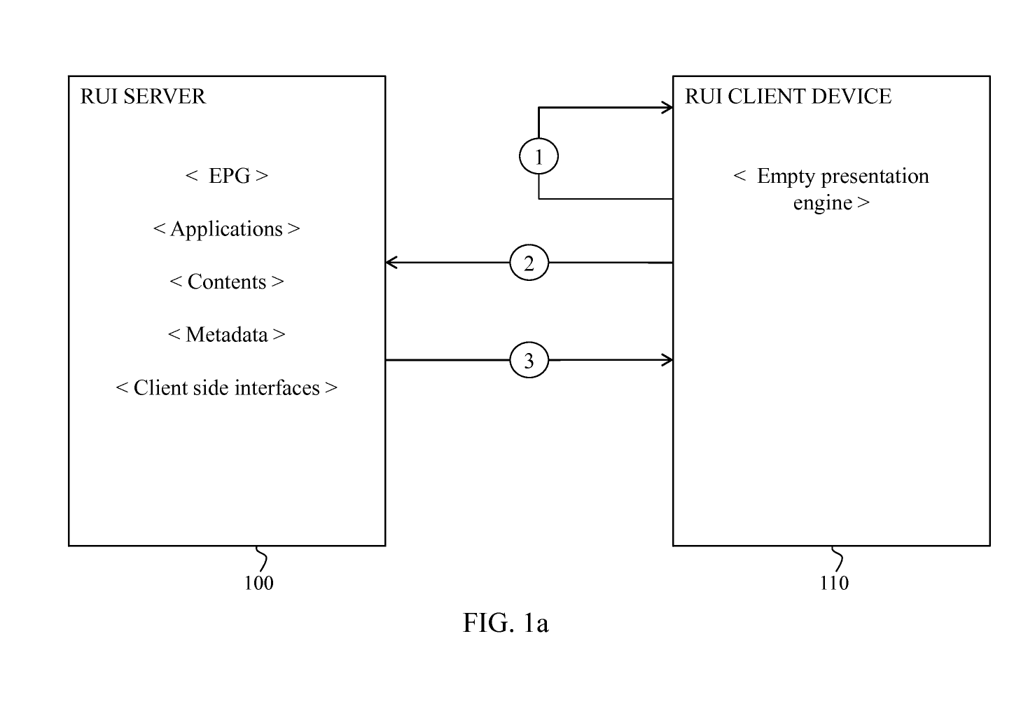

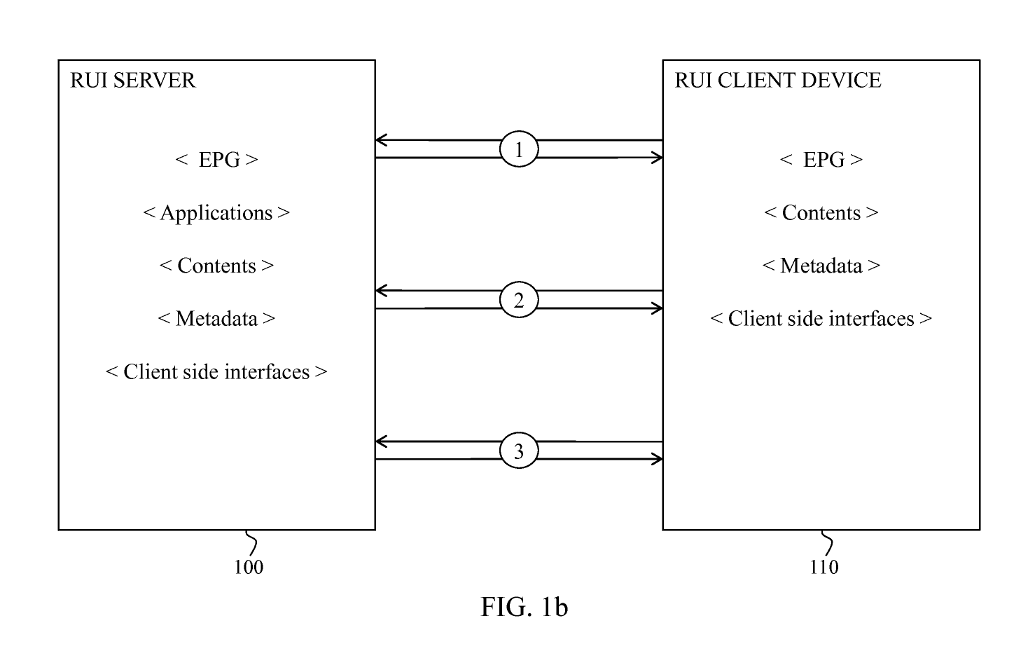

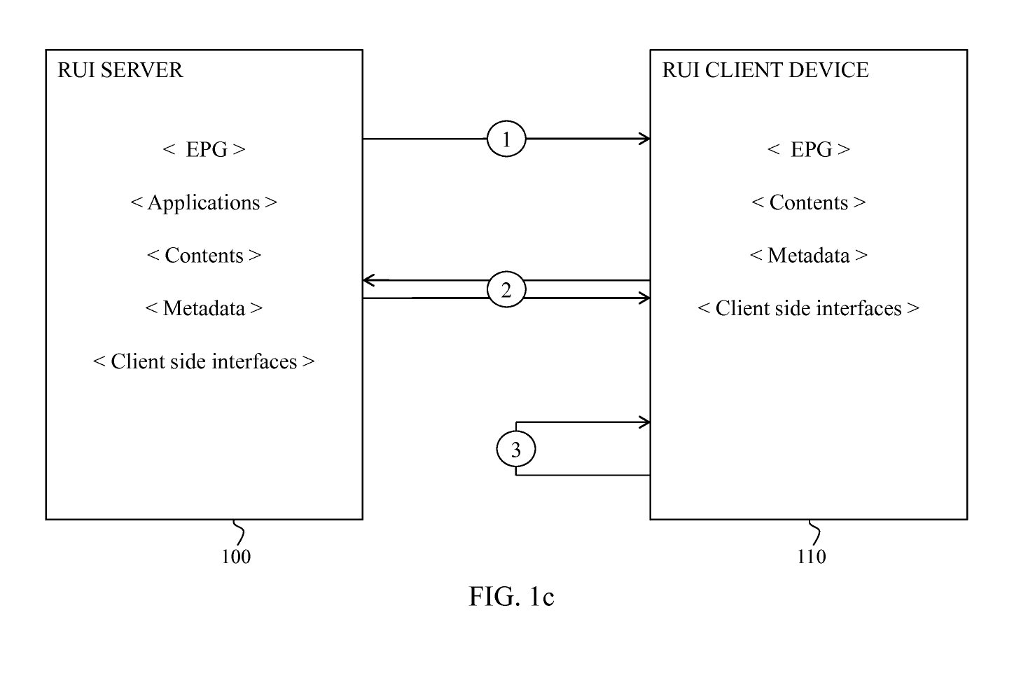

FIGS. 1a-1c are simplified block diagram illustrations of interaction sequences between a RUI server and a RUI client device according to embodiments of the present invention. FIGS. 1a-1c give a high level overview of communications between a RUI server 100 and a RUI client device 110 in a RUI enabled API system.

Reference is now made to FIG. 1a which is an illustration of a typical interaction sequence between a RUI server 100 and a RUI client device 110 according to an embodiment of the present invention.

FIG. 1a describes how a RUI client device 110 retrieves for example, but without limiting the generality of the invention, a RUI EPG (or any RUI application) from a RUI server 100. The RUI EPG may be used with any appropriate client device/terminal 110 operable to receive Audio-Video (AV) content (e.g. a STB operable to receive digital TV such as satellite TV, cable TV, and terrestrial or Internet Protocol TV (IPTV); a computer; a tablet computer; a Portable Media Player (PMP); a handheld device; etc.) and which allows a user to view, navigate, select and discover any type of content. At step 1, the RUI client device 110 boots up and is then ready to establish a communication with a RUI server 100.

At step 2, a communication is established between the RUI client device 110 and the RUI server 100. Then, the RUI client device 110 requests a RUI EPG (or a UI application) to be displayed. This request may be made by a user of the RUI client device 110 at any time or automatically generated by the RUI client device 110 either every time the RUI client device 110 is powered on or at regular time intervals.

At step 3, the RUI server 100 identifies the client device 100 and transmits the relevant RUI EPG. The RUI EPG typically enables a user to access and make use of one or more services. The RUI EPG may comprise for example, but without limiting the generality of the invention, UI layouts and data related to an EPG and/or any other UI applications, contents and associated metadata and at least one client-side interface. A client-side interface is typically an API (Application Programming Interface) implementation that enables a service to be made available at the RUI EPG.

Reference is now made to FIG. 1b which is an illustration of a typical interaction sequence between a RUI server 100 and a RUI client device 110 according to an embodiment of the present invention.

FIG. 1b describes a RUI EPG loading operation from a first device 100 (hereinafter referred as the RUI server 100) to a second device (hereinafter referred as the RUI client device 110). As described hereinabove in relation to FIG. 1a, the RUI client device 110 may request an EPG to be displayed. The EPG typically enables a user to access and make use of one or more services. Thereafter, a communication is established between the RUI client device 110 and a RUI server 100.

At step 1 of FIG. 1b, upon identification of the RUI client device 110 by the RUI server 100, the RUI client device 110 requests and receives from the RUI server 100 the client-side APIs. Then at step 2, the RUI server 100 requests and receives the UI layouts and data related to the RUI EPG. Finally, at step 3, the RUI client device 110 receives the contents and associated metadata relevant to the RUI EPG from the RUI server 100 and the RUI EPG is ready to be displayed and used by a user at the RUI client device 110.

Reference is now made to FIG. 1c which is an illustration of a typical interaction sequence between a RUI server 100 and a RUI client device 110 according to a further embodiment of the present invention.

FIG. 1c describes a sequence occurring when a notification is emitted by a RUI server 100 and received by a RUI client device 110. At step 1 of FIG. 1c, the RUI client device 110, which has previously loaded a RUI EPG, receives a notification from the RUI server 100. Typically, this notification may be a notification corresponding to an update of the RUI EPG. Then, at step 2, the RUI client device 110 processes the notification and requests in response to receiving the updated RUI EPG from the RUI server 100. Finally, at step 3, the RUI client device 110 dynamically updates the RUI EPG. Those skilled in the art will appreciate that the entire updated version of the RUI EPG may be delivered or that a subset of the RUI EPG corresponding to the update may be delivered to the to the RUI client device 110.

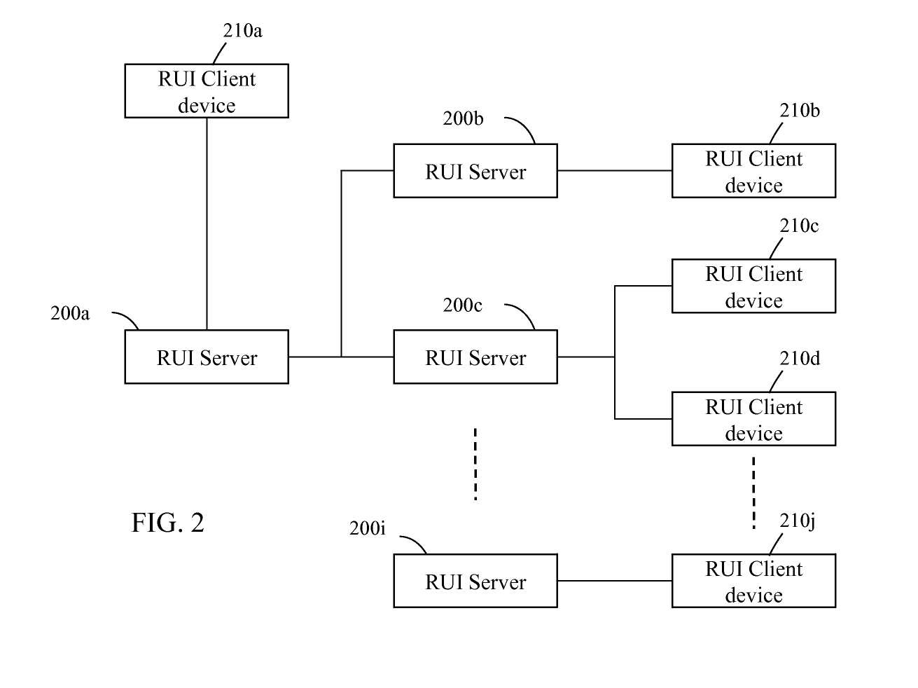

Reference is now made to FIG. 2 which is a simplified block diagram illustration of an exemplary infrastructure comprising RUI servers and RUI client devices according to an embodiment of the present invention.

The RUI enabled API system according to embodiments of the present invention also provides support for a multi-server and multi-client device infrastructure as shown in the exemplary RUI enabled API system infrastructure of FIG. 2. It will be apparent to someone skilled in the art that the current implementation also supports a single-server and single-client device approach as described in the RUI enabled API system of FIG. 1a-1c. The infrastructure of FIG. 2 shows a plurality of RUI servers 200a-200i that may be connected to a plurality of client devices 210a-210j. Therefore, a user of one particular client device of the plurality of the client devices 210a-210j may request and receive for example, but without limiting the generality of the invention, an EPG or any UI application from one RUI server of the plurality of RUI servers 200a-200i. The RUI EPG may then be retrieved and loaded on the user's client device for display and use.

The RUI servers 200a-200i may also be interconnected together. Therefore, in an embodiment of the present invention, a particular RUI server may act as a master RUI server (200a for example but without limiting the generality of the present invention). In such a case, the infrastructure is similar to a node or a tree structure wherein the infrastructure may include a master RUI server 200a and slave RUI servers 200b-200i acting as clients of the master RUI server 200a.

A particular RUI server may provide one or more services (e.g. live TV channels/programs, VOD, push-VOD or near-VOD catalog, recorded programs, user generated contents, etc.) for display and use at the client devices 210a-210j. The RUI enabled API system allows superposition of a plurality of services retrieved from several different RUI servers 200a-200i for transmission to client devices 210a-210j over a communications network. Technologies such as Common Request Broker Architecture (CORBA), Universal Plug and Play (UPnP), etc. are typically used to support cumulative servicing over a communications network.

In another embodiment of the present invention, the RUI client devices 210a-210j of the RUI enabled API system may be connected to any other suitable RUI servers 200a-200i and RUI client devices 210a-210j.

The RUI servers 200a-200i and the RUI client devices 210a-210j may be registered and identified so that the RUI enabled API system knows which communications network(s) and/or service(s) a particular RUI client device and/or a particular RUI server are authorized to access.

In a further embodiment of the present invention, the communication and identification protocols used between a master RUI server 200a and the slave RUI servers 200b-200i are the same as the ones used between RUI servers 200a-200i and RUI client devices 210a-210j.

Furthermore, a RUI server 200a-200i is also able to provide a plurality of UI applications such as for example, but without limiting the generality of the invention, an EPG, a game application, a widget application, a television application or any UI interactive application, etc. to RUI client devices 210a-210j. The plurality of UI applications may be written in several different programming languages—e.g. HyperText Markup Language (HTML) with Javascript, Flash with Actionscript, etc.—as long as these languages are supported by the presentation engines located in the RUI client devices 210a-210j.

The communication protocol used for communication between the RUI servers 200a-200i and the RUI client devices 210a-210j typically provides APIs and data models that support both pull (in response to a RUI client device request) and push (update/notification from a RUI server) modes. In a further embodiment of the present invention, pull and push APIs are socket-based such as for example, but not limited to, sockets and/or HTTP/HTTPS GET/PUT, with the use of a listener component located on the RUI client device side. This communication protocol is also scalable so that a RUI client device from the RUI client devices 210a-210j may request at its convenience a subset of the overall information available as part of the services. The subset may be for example, but not limited to, the next five channels or the ten first on-demand movies, etc. and this subset may be requested by a particular RUI client device at any time. Requesting and transmitting only a subset of information to RUI client devices 210a-210j enables the RUI enabled API system to accommodate the requests of a wider range of RUI client devices 210a-210j, each RUI client device 210a-210j having its own characteristics in terms of memory capacity, storage capacity or network connectivity (e.g. WiFi, ethernet, 3G or 4G, etc.).

On the RUI server side, the communication protocol also allows customizing replies to RUI client devices 210a-210j according to the capabilities and connectivity means of the RUI client devices 210a-210j. On the RUI client device side, the communication protocol allows receiving the different TV channels or TV programs and downloading EPG and/or UI applications as well as RUI client-side APIs. To do so, the requests sent from a RUI client device (210a for example) to a RUI server (200a for example) may include information related to the RUI client device (210a). In order to generate a customized reply to the RUI client device (210a), a set of parameters that specifically characterizes the characteristics and the capabilities of the RUI client device (210a) may be sent to the RUI server (200a) along with the request thereby allowing at least identification of the RUI client device (210a). This set of parameters typically defines a type of the client device (210a) and may include for example, but not limited to: an identifier of the RUI client device (210a); type, size and format of data supported by the RUI client device (210a); type of input device(s) associated with the RUI client device (210a); type of connectors supported by the RUI client device (210a); etc.

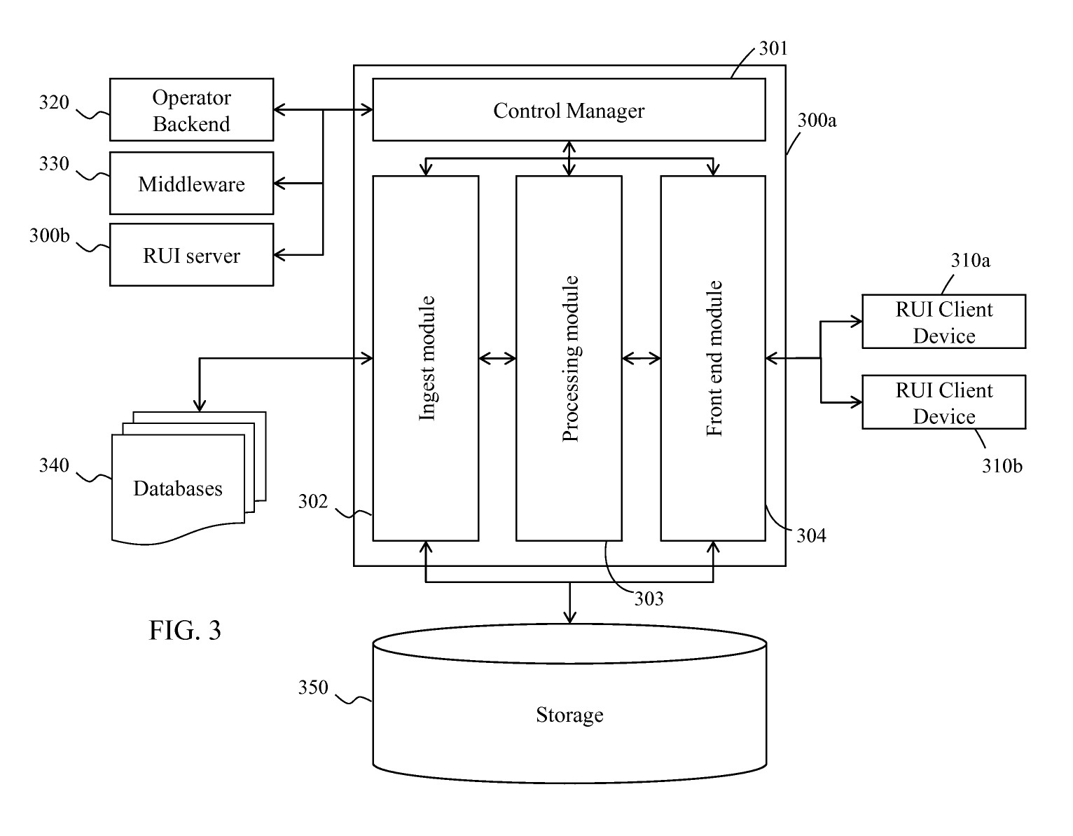

Reference is now made to FIG. 3 which is a simplified block diagram illustration of a RUI server in a RUI enabled API system according to an embodiment of the present invention.

A RUI server 300a is typically located on the server side and includes different modules such as, but not limited to, an ingest module 302, a front end module 304, a processing module 303 and a control manager module 301. It will be apparent to those skilled in the art that it is possible to physically organize these modules in any appropriate manner. Similarly, the RUI server 300a may also be provided as a standalone component or may be integrated into a more complex application.

The ingest module 302 typically retrieves UI layouts and data for an EPG and/or UI applications, metadata (e.g. additional information and/or description related to a TV program part of a channel line-up), assets (e.g. a channel logo), etc., all of them potentially being of different formats and coming from a plurality of databases 340. FIG. 3 shows remote databases 340 that are communicating with the ingest module 302. Those skilled in the art will appreciate that these databases may include local databases i.e. integrated within the RUI server 300a. Then, the ingest module 302 formats the metadata and the assets into a format of preference as defined by the RUI enabled API system. It will be apparent to those skilled in the art that the RUI enabled API system of embodiments of the present invention are not limited to a single or a particular format but on the contrary may support a wide range of implementation formats such as, but not limited to, REpresentational State Transfer (REST), eXtensible Markup Language (XML), or JavaScript Object Notation (JSON), etc. In another embodiment of the present invention, the processing module 303 may be used to convert the assets in lieu of the ingest module 302.

Once retrieved and formatted, the UI layouts and data, metadata and assets are stored in a storage component 350 for later access. FIG. 3 shows an external storage component 350 but it will be apparent to someone skilled in the art that this storage component 350 may be integral with the RUI server 300a. In both cases, the storage component 350 may be a high capacity storage device, such as a hard disk or a high capacity memory. Alternatively, the storage component 350 may also be implemented as a file-system based physical device that may be cached into a memory.

The RUI server 300a also includes a front end module 304, which is the communication interface with the RUI client devices 310a and 310b. For simplicity of description and depiction, but without limiting the generality of the present invention, only two client devices 310a and 310b have been represented in FIG. 3. The front end module 304 typically receives requests from the RUI client devices 310a and 310b and passes the requests to the processing module 303.

Once the requests are processed by the processing module 303, the front end module 304 is also operative to send replies to the RUI client devices 310a and 310b. To do so, the front end module 304 is therefore able to retrieve UI layouts and data, for EPG or UI applications, as well as formatted assets and metadata from the storage component 350. In another embodiment of the present invention, the front end module 304 is also able to push information (e.g. notification of an update, remote commands, etc.) to RUI client devices 310a and 310b.

Again, the RUI enabled API system, according to embodiments of the present invention, may use a wide range of technologies for enabling connection and communication as well as for ensuring interoperability with the RUI client devices 310a and 310b. The front end module 304 may use for example, but without limiting the generality of the present invention, sockets for connections such as Web sockets and HyperText Transfer Protocol (HTTP)/HTTP Secure (HTTPS), and/or may contain adapters for ensuring the interoperability with some RUI client devices 310a and 310b that may have specific characteristics e.g. DLNA, Hybrid broadcast broadband TV (HbbTV), etc.

The processing module 303 typically receives the RUI client devices requests from the front end module 304. Then, the processing module 303 processes the requests and generates customized replies. This processing module 303 typically performs some adaptions depending on the RUI client device 310a/310b type (e.g. DLNA client) at the time when the replies are generated. The processing module 303 may for example, but without limiting the generality of the invention, convert a picture into a particular format or resolution, so that the picture will be suitable for display at the RUI client device 310a/310b which sent the request. The processor module 303 may also identify API implementations that are associated to one or more services requested by the RUI client device 310a/310b. These identified API implementations ensure that the one or more services will be available for use on the RUI client device 310a/310b. In another embodiment of the present invention, components external to the processing module 303—e.g. an external transcoder or a DLNA software component—may be used to perform these adaptions.

The RUI server 300a also includes a control manager module 301 that controls the correct functioning and monitors the overall state of the RUI server 300a. The RUI server 300a also manages identification of the RUI client devices 310a and 310b—including identification of their characteristics—thereby ensuring that the RUI client devices 310a and 310b are connected to the relevant operator backend server 320. The control manager module 301 may further interact and exchange data with:
an operator backend 320. This operator backend 320 is typically the operator headend that: manages registration and identification of the different devices within the communications network including the RUI client devices 310a and 310b; controls broadcast and/or broadband operations including delivery of AV contents; etc. The operator is therefore able to use this communication link to publish and/or notify the RUI server 300a of any modification or update such as for example, but without limiting the generality of the invention, an update of the UI layout or an availability of a new VOD assets;
a middleware 330. This communication link may be present in a case where the RUI server 300a is integrated in a platform like a Consumer Premises Equipment (CPE) e.g. a set-top box (STB) or a gateway (GW). The RUI server 300a may also be servicing RUI client devices 310a and 310b in a home network. In such a case, the communication link may be used to retrieve different types of information such as, but not limited to, Quadrature Amplitude Modulation (QAM)/broadcast channels received directly on the CPE, home network contents (e.g. DLNA based contents), etc.; and
another RUI server 300b located upstream or downstream i.e. a master or a slave RUI server. This communication link may be used as a proxy for an upstream server in a complex communications network infrastructure to improve its reliability, bandwidth and response time to RUI client devices 310a and 310b. Furthermore, this communication link may also be used in a situation where the RUI server 300a is integrated into different service platforms e.g. headend or GW.

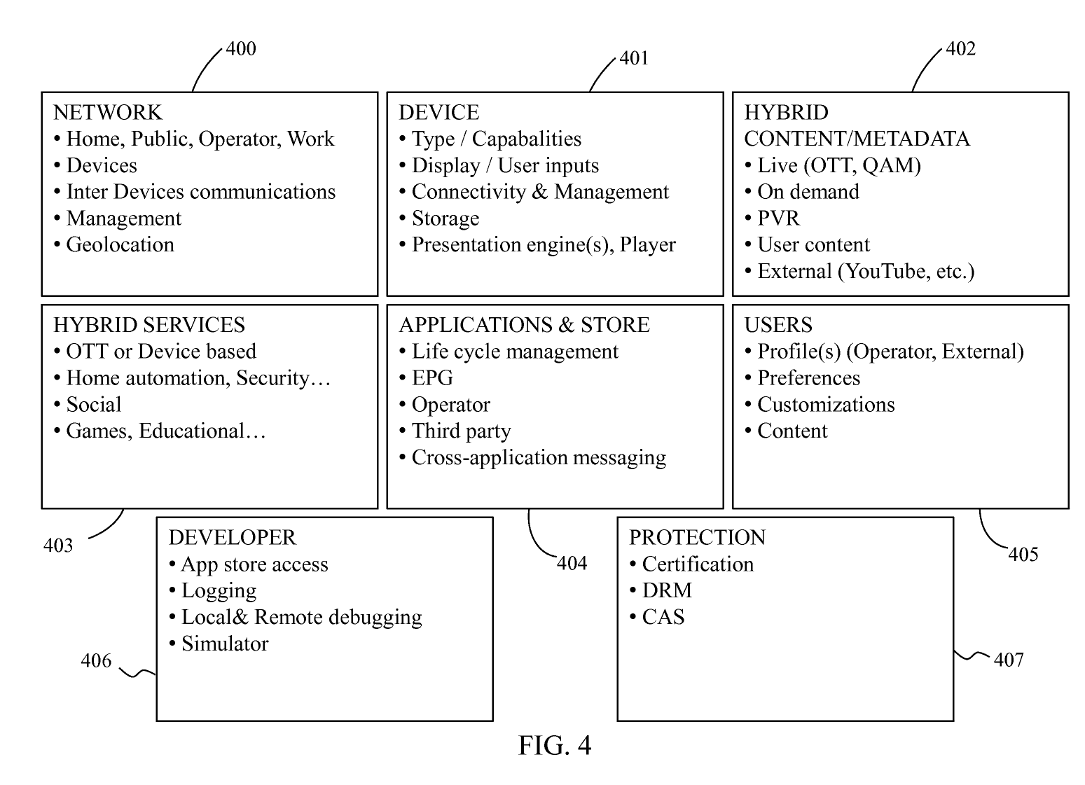

Reference is now made to FIG. 4 which is a simplified block diagram illustration of features which may be made available to RUI client devices.

To offer a number of services in a unified manner to a plurality of RUI client devices, these services are typically abstracted so that they can be exposed in a generic manner. Therefore, the services may be available to and accessed seamlessly from different RUI client devices and across different communications networks. Similarly, characteristics of RUI client devices and communications networks are also typically abstracted. Therefore, these abstractions help the services to be run on a large ecosystem of RUI client devices through heterogeneous communications networks.

In an embodiment of the present invention, several features enabling a plurality of services to be made available to a plurality of RUI client devices through the RUI enabled API system, are clustered into different categories as shown in FIG. 4 (e.g. network 400, device 401, content and metadata 402, hybrid services 403, applications 404, users 405, developer 406 and protection 407) and stored in an abstracted form in the storage component 350 on the RUI server side. It will be apparent to those skilled in the art that these clusters may be organized in any appropriate manner. Each clustered feature comprises one or more API implementations enabling the feature. In another embodiment of the present invention, a plurality of API implementations enabling a plurality of features is stored on the RUI server side. Each feature is enabled by at least one API implementation of the plurality of API implementations. Furthermore, a service may be enabled by a plurality of features. When a RUI client device requests a particular service to be available for display and use, then the RUI client device typically identifies a plurality of features for enabling the service. For example, but without limiting the generality of the invention, a service such as a VOD catalog may be requested to be available at the RUI client device, therefore requiring the RUI client device to identify relevant features related to the VOD catalog (e.g. user inputs supported by the RUI client device to interact with the VOD catalog, video player used by the RUI client, etc.). Then, the RUI client device typically identifies one relevant API implementation for each feature that may be related to the service. To do so, the RUI client device sends a request to the RUI server and the relevant API implementations are retrieved from the relevant clusters for the features, thereby enabling the RUI client device to use the service in an optimal manner. The clustered features that enable different services to be made available for access and use at the RUI client device comprise:
Network features using the Network cluster 400: this cluster 400 provides information relevant to the communications network on which a RUI client device is connected e.g. operator communications network, home network or any other user defined network. Network information is typically retrieved by Internet Protocol (IP) connectivity including the Media Access Control (MAC) address of an IP router.
This cluster 400 also provides information relevant to further RUI client devices that may be connected on the same communications network. This information is typically retrieved by sending a request upstream to an IP router. Those skilled in the art will appreciate that a RUI client device and an IP router may be, in certain situations, the same device.
Additionally, this cluster 400 provides means (i.e. API implementations) for communicating to several RUI client devices so that different RUI client devices are able to communicate with each other. This communication is typically initiated and managed by the RUI server to which the RUI client devices are connected. In another embodiment of the present invention, one or more RUI client devices are able to initiate direct communication but still under the supervision of the RUI server.
Furthermore, this cluster 400 provides means (i.e. API implementations) for controlling RUI client devices through a remote management system using protocols such as Technical Report 069 (TR-069) of the Broadband Forum, Technical Report 135 (TR-135) of the Broadband Forum or Simple Network Management Protocol (SNMP). Other native protocols may also be used independently or in combination.
Finally, this cluster 400 also provides geolocation information relevant to a RUI client device. The HTML5 geolocation feature may be used and/or a static location may be installed on the RUI client device. The latter is well suited to situations where a RUI client device is not mobile (e.g. a STB). In such a case, the operator is able to load in advance this static location information using the subscriber's information;
Abstracted device features using the Device cluster 401: this cluster 401 detects and provides information relevant to the type and capabilities of a RUI client device. This information is typically retrieved from a user agent or a MAC address of a RUI client device. Other native protocols (e.g. SNMP) may also be used independently or in combination.
This cluster 401 also provides means (i.e. API implementations) for enabling communication between different presentations engines located on a same platform. A local socket is typically used for enabling this bidirectional communication.
Additionally, this cluster 401 provides information relevant to input device(s) that may be used by a RUI client device. APIs on the RUI client device side typically provide information relevant to generic events/gestures that may be used and understood by an application.
Furthermore, this cluster 401 provides connectivity information. Applications may not rely on a specific connection to be normally executed. This cluster 401 also provides means (i.e. API implementations) for resizing and rescaling a visual element (that may be part, for example, of an EPG or a UI application) on a RUI client device screen. In an embodiment of the present invention, this cluster may also provide means (i.e. API implementations) for interpreting metadata relevant to three dimensional (3D) displays.
Finally, this cluster 401 further provides means (i.e. API implementations) for managing a RUI client device storage and/or cache. Different types of storage devices such as HTML5 web storage, a memory, a Structured Query Language (SQL) server or cookies may be used independently or in combination;
Abstracted sources and/or contents using the Hydrid Content/Metadata cluster 402 and Services using the Hybrid Services cluster 403: these clusters 402-403 provides contents and/or services characteristics such as, but not limited to: source types (e.g. DLNA, QAM, OTT, social networks, home automation, etc.), local optimizations (i.e. the optimal format to be used on a particular platform), etc.;
Application and store features using the Application & Store cluster 404: this cluster provides means (i.e. API implementations) for managing the lifecycle of an application. The lifecycle includes starting, running and closing an application on a RUI client device under the control of a RUI server. The communication protocol used between a RUI server and a RUI client device typically includes a messaging protocol based on events generated for installing, controlling and updating the application. Additionally or alternatively, these events may be used for managing and updating a main application such as an EPG. The events may also include events for saving an execution context and a state of an application over a communications network and/or locally on a RUI client device, thereby allowing the application to be resumed later at the saved state using the saved execution context. These events are typically related to operator's applications but may further include public events and methods that may be used by a third party entity to develop an application. Finally, the events may further include private events enabling several applications to communicate with each other (e.g. by posting messages and/or notifications);
User related features using the User cluster 405: this cluster 405 provides means (i.e. API implementations) for managing a plurality of users. The communication protocol used between RUI client devices and RUI servers typically includes means (i.e. API implementations) for identifying a user by use of a login and/or a password. The communication protocol is also able to retrieve and save users profiles and preferences, therefore providing a same customized/personal environment whichever RUI client devices are used by a particular user. For example, customized contents and/or customized UI layouts may be displayed seamlessly on all the RUI client devices relevant to a particular user.
Developer features using the Developer cluster 406: this cluster 406 enables developers to submit new applications to operators and/or subscribers. The communication protocol used between RUI client devices and RUI servers typically includes means (i.e. API implementations) for developing, testing and publishing an application. Any developer may therefore develop his own application in a language compliant and executable by a presentation engine.
The communication protocol may further includes means (i.e. API implementations) for searching, selecting, buying, installing (and uninstalling) and accessing an application published by a developer. Furthermore, the communication protocol may further include means (i.e. API implementations) for logging and tracing errors as well as means (i.e. API implementations) for debugging an application. Additionally, it may include means (i.e. API implementations) for setting a RUI server into simulation mode. The latter is achieved by storing static data on a RUI server without connecting it to an operator backend, or to databases, etc.
Content protection features using the Protection cluster 407: this cluster 407 provides means (i.e. API implementations) for registering and identifying RUI client devices owned by a user over a communications network, thereby allowing a secure access to contents and services. This cluster 407 further provides means (i.e. API implementations) for accessing secured contents and/or applications. Registration, identification, access rights and certifications are typically managed by the operator backend and communicated to the RUI client devices. These RUI client devices include means (i.e. API implementations) for receiving the information as well as secure contents and/or applications so that a decrypting operation may be locally performed on the RUI client device.

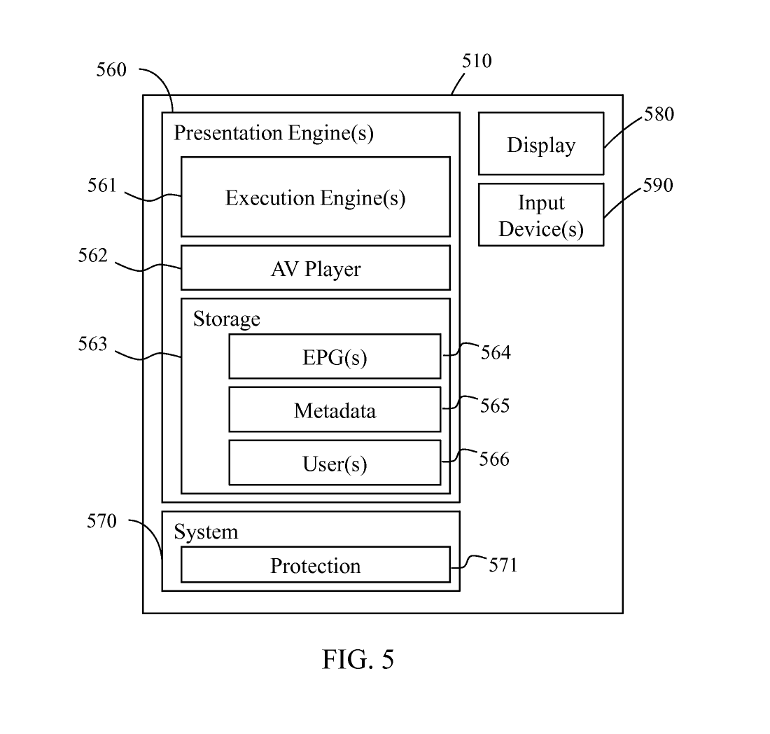

Reference is now made to FIG. 5 which is a simplified diagram illustration of a RUI client device according to an embodiment of the present invention.

The RUI enabled API system typically includes at least one RUI client device 510 on the client device side. The RUI client device 510 comprises different functional modules such as, but not limited to, a display module 580, an input module 590, at least one presentation engine 560, an execution engine module 561, an AV player module 562, a storage module 563, an operating system module 570 and a protection module 571. Those skilled in the art will appreciate that additional modules may be embedded in the RUI client device 510 (e.g. additional modules for a personal computer or a tablet computer) and that these modules may be organized in any appropriate manner.

The display module 580 typically displays the output of the presentation engine 560. It will be appreciated by those skilled in the art that although shown in FIG. 5 as being integrated into the RUI client device 510 which may be the case for laptop or tablet computers and handheld devices, the display module 580 may also be disposed outside and connected to the RUI client device 510 e.g. a TV connected to the RUI client device 510 with High Definition Memory Interface (HDMI) or Video Graphics Array (VGA) connectors for example. Additionally or alternatively, the RUI client device 510 may also have multiple display modules 580 e.g. more than one display module 580 such as a Nintendo DS™ or may have 3D capabilities.

The input module 590 typically enables a user to control and interact with an application currently being executed such as an EPG or any other UI application. The input module 590 typically receives input controls data from one or more input devices such as, but not limited to: a mouse, a keyboard, a touchpad, a tactile screen, a remote control, a 3D camera, etc. In another embodiment of the present invention, an input device module may be an input proxy module 590 so that the RUI client device 510 is able to receive inputs commands/events from an external input device e.g. events generated by a tablet computer to control a connected television.

The presentation engine module 560 typically comprises at least one presentation engine. A presentation engine is typically in charge of rendering graphical elements (e.g. control buttons, menus, etc. of a UI) on the display module 580. Many different presentation engines exist (e.g. HTML5 browser, Flash, Java, native or Unity 3D engines) and may therefore be used to handle declarative TV applications.

The execution module 561 is typically embedded within the presentation engine module 560 e.g. Javascript for HTML5 or Actionscript for Flash. The execution engine module 561 is a processor that typically executes interactive TV applications for rendering them on the display module 580.

The AV player module 562 typically receives and decodes AV streams for display on the display module 580. The AV player 562 is also able to communicate with the content protection module 571 thereby allowing decryption of encrypted AV streams under the control of the content protection module 571. Although shown as being integrated in the presentation engine module 560, the AV player 562 may also be provided as a separate module. The AV player 562 is further able to support a plurality of AV streams thereby enabling a picture in picture functionality.

The storage module 563 typically stores data downloaded from the RUI server such as UI layouts and data 564, assets 564, metadata 565 and user information 566. This module 563 may be any type of storage device such as, but not limited to, a memory, a cache, a database, etc. Although shown as being integrated in the presentation engine module 560, the storage module 563 may also be provided as a separate module.

The operating system module 570 typically manages hardware resources such as the available memory. The operating system module 570 may be any available operating system e.g. Linux, Windows or iOS and may be seen as a specific application like a middleware.

Finally, the content protection module 571 typically handles access rights thereby ensuring that the subscribers have access to secure and encrypted contents and/or services. This module 571 may be implemented as a hardware component included in the operating system module 570 or as a software component.

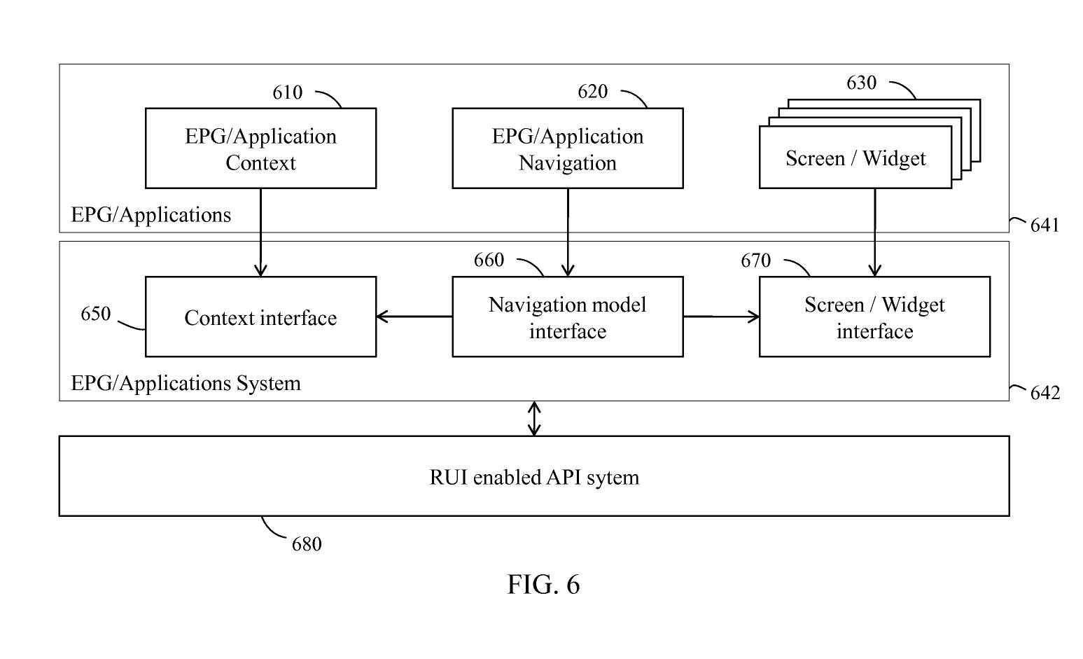

Reference is now made to FIG. 6 which is a simplified block diagram illustration of an RUI EPG and Applications system according to an embodiment of the present invention. A RUI EPG or a UI application typically enables a user to access and make use of one or more services. The RUI EPG or a UI may of the RUI EPG and Applications system comprise one single page or more pages that can be accessed and navigated by a user. Furthermore, the different pages of the RUI EPG or UI application may comprise one or more visual element that can be displayed as screens and/or widgets. Therefore, a user may navigate through the RUI EPG or UI application and requests for example, but not limited to, to switch from one visual element to another visual element.

By way of introduction, the following definitions will aid understanding of the embodiments of the present invention.

Widget: a widget is a visual element of a graphical user interface that is typically not displayed in full screen mode and therefore partially covers/overlays another display element such as, for example, a video or an EPG. A widget typically displays information and provides a specific way for a user to interact with the operating system and application.

Screen: a screen is a visual element of a graphical user interface that is typically displayed in full screen mode. A screen may also display information and provide a specific way for a user to interact with the operating system and application.

The RUI EPG and Applications system 642 may be transmitted along with the RUI from a RUI server to be run on a RUI client device. In another embodiment of the present invention, the RUI EPG and Applications system 642 may be already integrated within a RUI client device.

The RUI EPG and Applications system 642 defines an improved navigation model that proposes several interfaces separating the EPG and/or applications layouts and data from the actual navigation. In other words, the RUI EPG and Applications system 642 separates how to navigate from one widget/screen of the EPG/application to another widget/screen from the actual layouts and data. This separation allows parallelized development of each widget or screen for later integration into the overall navigation model. It also allows management of the lifecycle of an EPG and/or applications, even on a per-screen basis, and aims to reduce development time and integration costs, while optimizing the use of the RUI enabled API system 680. Integration is simplified by enabling early development of the navigation model, prior to delivering each widget or screen. Once mature enough, a widget/screen may be integrated in lieu of a default widget/screen that was used to validate the navigation model. Furthermore, the navigation model defined by the RUI EPG and Applications system is dynamic thereby allowing insertion or removal of new visual elements (widgets and/or screens), even at run time.

The RUI EPG and Applications system 642 includes a context interface 650, a navigation model interface 660 and a screen/widget interface 670 as shown in FIG. 6.

The navigation model interface 660 is typically able to receive events and/or notifications from the RUI enabled API system 680. Events are typically initiated by a user input. Notifications are typically initiated from a RUI server and/or a RUI client device e.g. system error message, new email or message, message from an external or internal application, etc.

The navigation model interface 660 defines a navigation model i.e. a decision to show or hide a specific widget or screen according to a received event/notification. For example, but without limiting the generality of the invention, the navigation model interface 660 may decide to open a TV program grid in response to a user pressing a button on a remote control.

The navigation model interface 660 is further able to graphically layer different widgets and/or screens. This may be achieved for example, but without limiting the generality of the invention, by using the “z-index” feature of the Cascading Style Sheets (CSS) standard for HTML5.

Furthermore, the navigation model interface 660 also controls the lifecycle of each widget/screen e.g. processes the received event that requests the opening or the closing of a particular widget/screen. This improves resource management (computer processing unit and memory) on a per widget/screen-basis.

The RUI EPG and Applications system 642 also includes a widget/screen interface 670 operable to receive events and notifications from the RUI enabled API system 680. Events are typically the same as the ones described hereinabove in the present specification in relation to the navigation model interface 660. Events are typically initiated by a user input. Notifications are typically initiated from a RUI server and/or a RUI client device e.g. system error message, new email or message, message from an external or internal application, etc.

The widget/screen interface 670 defines the navigation model for a particular widget/screen. For example, but without limiting the generality of the present invention, the widget/screen interface 670 may be able to manage the display of and navigation through a VOD library (displayed in a widget or in a screen) comprising a plurality of VOD assets.

The widget/screen model interface 670 may include for example, but without limiting the generality of the invention, means (i.e. API implementations) for:
retrieving visual properties of a visual element. The visual element properties include for example, but not limited to, size, aspect ratio and 3D capabilities;
retrieving input properties supported by a visual element. The input properties typically include the type of events and/or notifications that a particular visual element is able to receive and process. Upon reception of an event and/or a notification, a widget/screen may notify capture or dismiss of an event and/or notification to the navigation model interface 660. In another embodiment of the present invention, a widget/screen is also able to send a state machine event to another widget/screen; and
controlling the lifecycle of a visual element. The widget/screen model interface 670 typically enables creating, initializing, starting, pausing, resuming, closing, deleting and bringing the visual element on and off the display.

The RUI EPG and Applications system 642 further comprises a context interface 650. A context is information that is shared by the navigation model interface 660 and the widget/screen interface 670 during execution on the RUI client device. The context interface 650 typically stores execution information such as, but not limited to, user information (e.g. profiles or preferences), content currently being viewed (e.g. current channel and type of content such as VOD, live, record, catch-up, etc.), content currently being browsed and widgets/screens currently being used and/or displayed. This information is stored in a format compliant to the RUI format. The context interface 650 may also include means (i.e. API implementations) for transferring a context from a RUI client device to another RUI client device as long as both RUI client devices are running the same RUI, which may be the case in situations where for example, but not limited to, a RUI client device acts as a RUI server for another RUI client device, or when a same RUI has been transmitted to a plurality of RUI client devices, etc. To do so, the context interface 650 may provide means (i.e. API implementations) for copying and saving the context before the transfer operation and means (i.e. API implementations) for executing the context on the receiving RUI client device upon completion of the transfer operation.

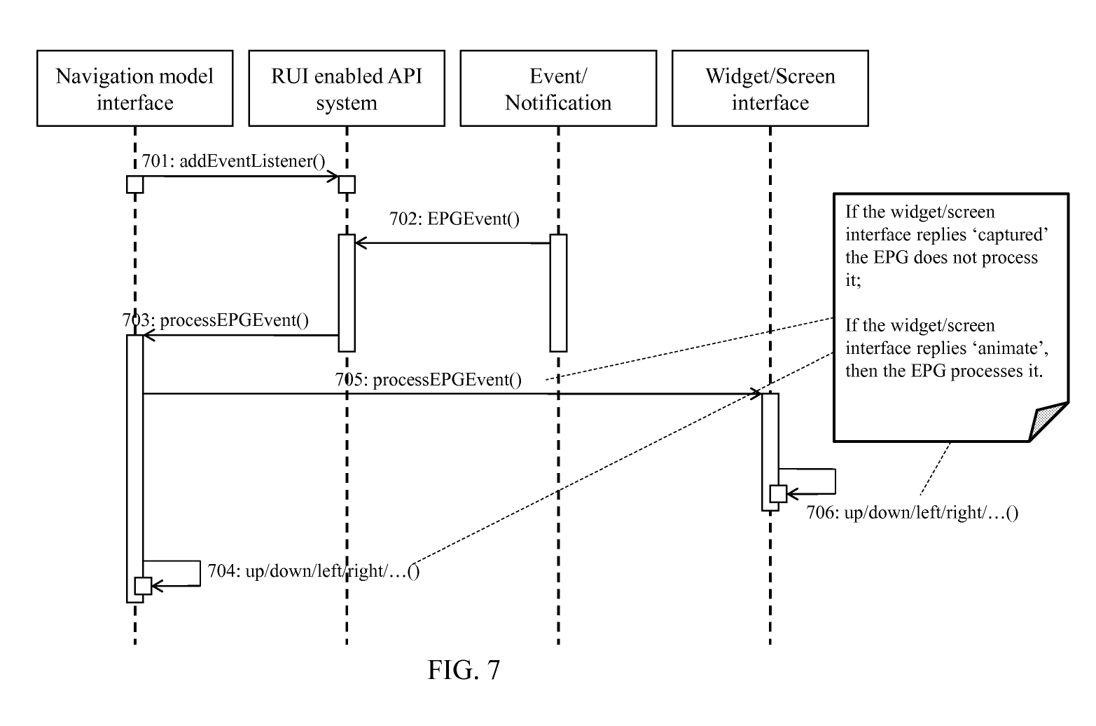

Reference is now made to FIG. 7, which is a simplified diagram illustration showing a sequence of operations in the RUI EPG and Application system according to an embodiment of the present invention.

At step 701, a connection is established between the navigation model interface 660 of the RUI EPG and Application system 642 and the RUI enabled API system 680. The navigation model interface 660 is therefore “listening for” any event and/or notification that will be received by the RUI enabled API system 680.

At step 702, an EPG event or an EPG notification is received at the RUI enabled API system 680. This EPG event or notification may be received from a RUI server (e.g. notification from a TV operator of an availability of a new VOD asset) or from a user operating the RUI EPG either using a remote control device or the RUI client device itself. In this situation, the EPG event may be relevant to a screen or a widget currently being displayed.

In any case, the EPG event or notification is forwarded to the navigation model interface 660 and a determination is made by the navigation model interface 660 to determine whether the event or notification apply to a particular widget/screen or not. Then, the navigation model interface 660:
may process the event or notification at step 704 if the widget/screen does not capture (i.e. dismisses) it and performs a related action if a machine state applies; or
does not process the event or the notification if the widget/screen captures the EPG event or notification (step 705). Then, the widget/screen interface 670 (not shown) performs a related action at step 706.
   The widget/screen is also operable to send a state machine event to the navigation model interface 660 which might also be the case after processing an event/notification at the widget/screen interface 670.

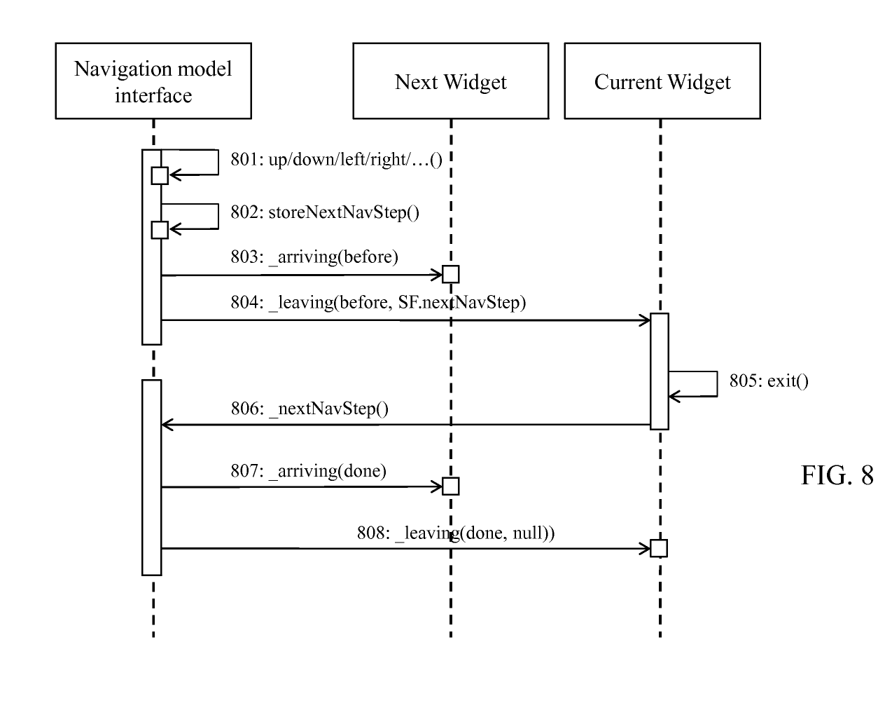

Reference is now made to FIG. 8, which is a simplified diagram illustration of a sequence of operations to switch from one widget to another in accordance with an embodiment of the present invention.

At step 801, the navigation model interface 660 processes an event and performs a related action (up/down/left/right/ . . . ). This related action may be, for example, but not limited to, to close the widget currently being displayed and open another one. Then, at step 802, context information is stored at the context interface (not shown) and typically corresponds to the instruction related to the next navigational step i.e. to display the next widget in this case. Storing such context information is typically useful in situations where an animation or a transition—e.g. zoom in, zoom out, fade, etc.—is to be played before the actual display of the widget.

At step 803, the next widget is informed that it will be displayed. A related action may also be performed such as updating or merely retrieving layouts, contents or data that are to be displayed. Also, at step 804, the instruction to stop displaying the current widget is sent to and processed at step 805. The current widget is closed and the next navigational step is requested from the navigation model interface 660. The context information is retrieved and the next widget is displayed at step 807 when the closing animation of the current widget and/or the opening animation of the next widget are finished. Finally, a further instruction may be sent at step 808 to the current widget thereby removing data related to the current widget no longer useful from the memory.

Although the above embodiments have been described as being carried out on the client and/or the server side, someone skilled in the art will appreciate that various features of the present invention may be implemented in intermediate network components.

It is appreciated that various features of the present invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by people skilled in the art that the present invention is not limited by what has been particularly shown and described hereinabove. Rather the scope of the invention is defined only by the claims which follow.

1. A method comprising:
providing at a first device:
a plurality of API implementations enabling a plurality of features such that, each of said plurality of features is enabled by at least one of said plurality of API implementations, said plurality of features enabling a plurality of services such that each of said plurality of features at least partially enables at least one of said plurality of services; and
a plurality of user interface applications, each of said user interface applications enabling one or more services from said plurality of services to be accessed and used at a second device, each of said user interface applications comprising layouts, assets and metadata related to each of said one or more services from said plurality of services;
receiving a request for transmitting a user interface application to a second device, wherein said request comprises a set of parameters characterizing said second device;
identifying said second device using said set of parameters;
upon identifying said second device:
retrieving layouts relevant to each of said one or more services from said plurality of services enabled by said requested user interface application;
converting assets and metadata in a format suitable for use by said second device for each of said one or more services from said plurality of services enabled by said requested user interface application; and
identifying API implementations from said plurality of API implementations to provide to said identified second device, wherein one or more features from said plurality of features is enabled by said identified API implementations, and wherein said one or more features enable said one or more services to be accessed and used at said identified second device; and
transmitting said identified API implementations along with said retrieved layouts, said converted assets and metadata for said requested user interface application from said first device to said identified second device.

2-3. (canceled)

4. The method of claim 1, wherein said requested user interface application comprises a plurality of visual elements for display.

5. The method of claim 4, wherein said receiving comprises receiving a request for transmitting a subset of a user interface application and said subset corresponds to a particular visual element of said user interface application.

6. The method of claim 5, wherein said particular visual element is a single page of said user interface application being displayed in full screen.

7. The method of claim 5, wherein said particular visual element is a widget of said user interface application not being displayed in full screen.

8. The method of claim 1, wherein said receiving comprises receiving a request from a user of said second device.

9. The method of claim 1, wherein said receiving a request from a second device comprises receiving a request for transmitting a user interface application every time said second device is powered on.

10. The method of claim 1, said method further comprising:
receiving a further request for transmitting an updated user interface application to said identified second device; and
transmitting said updated user interface application to said identified second device.

11. The method of claim 10, wherein said receiving a further request comprises receiving said further request from said identified second device upon reception by said identified second device of a notification transmitted by said first device, said notification signaling an update of said user interface application.

12. The method of claim 11, wherein said notification is transmitted by a television operator headend.

13. The method of claim 11, wherein said notification signals an availability of a new service relevant to said second device.

14. (canceled)

15. The method of claim 11, wherein said notification signals an availability of a new layout for said user interface application.

16. (canceled)

17. The method of claim 11, wherein said notification signals an availability of new assets for said user interface application.

18-19. (canceled)

20. The method of claim 10, wherein said receiving a further request comprises receiving a further request from said identified second device upon reception by said identified second device of a user input requesting said user interface application to switch from one visual element to another visual element.

21. The method of claim 1, wherein said set of parameters characterizing said second device comprises one or more of:
an identifier of said second device;
information on data supported by said second device;
types of input devices associated to said second device; and
types of connections supported by said second device.

22-24. (canceled)

25. A server comprising:
a storage module operable to store a plurality of API implementations enabling a plurality of features such that, each of said plurality of features is enabled by at least one of said plurality of API implementations, said plurality of features enabling a plurality of services such that, each of said plurality of features at least partially enables at least one service of said plurality of services; and further operable to store a plurality of user interface applications, each of said user interface applications enabling one or more services from said plurality of services to be accessed and used at a second device, each of said user interface applications comprising layouts, assets and metadata related to each of said one or more services from said plurality of services;
a front end module operable to receive a request for transmitting a user interface application to a second device, wherein said request comprises a set of parameters characterizing said second device;
a control manager operable to identify said second device using said set of parameters;
a processor module operable to identify API implementations from said plurality of API implementations to provide to said identified second device, wherein one or more features from said plurality of features is enabled by said identified API implementations, and wherein said one or more features enable said one or more services to be accessed and used at said identified second device; and further operable to convert assets and metadata in a format suitable for use by said second device for each of said one or more services from said plurality of services enabled by said requested user interface application;
wherein, said front end module is further operable to retrieve layouts relevant to each of said one or more services from said plurality of services enabled by said requested user interface application; and further operable to transmit said identified API implementations along with said retrieved layouts, said converted assets and metadata for said requested user interface application from said first device to said identified second device.

26. A server comprising:
means for storing a plurality of API implementations enabling a plurality of features such that, each of said plurality of features is enabled by at least one of said plurality of API implementations, said plurality of features enabling a plurality of services such that, each of said plurality of features at least partially enables at least one service of said plurality of services; and for storing a plurality of user interface applications, each of said user interface applications enabling one or more services from said plurality of services to be accessed and used at a second device, each of said user interface applications comprising layouts, assets and metadata related to each of said one or more services from said plurality of services;
means for receiving a request for transmitting a user interface application to a second device, wherein said request comprises a set of parameters characterizing said second device;
means for identifying said second device using said set of parameters;
means for retrieving layouts relevant to each of said one or more services from said plurality of services enabled by said requested user interface application;
means for converting assets and metadata in a format suitable for use by said second device for each of said one or more services from said plurality of services enabled by said requested user interface application; and
means for identifying API implementations from said plurality of API implementations to provide to said identified second device, wherein said one or more features from said plurality of features is enabled by said identified API implementations, and wherein said one or more features enable said one or more services to be accessed and used at said identified second device; and
means for transmitting said identified API implementations along with said retrieved layouts, said converted assets and metadata for said requested user interface application from said first device to said identified second device.
